(19) United States
(12) Patent Application Publication
(10) Pub. No.: US 2023/0389676 A1
(43) Pub. Date: Dec. 7, 2023

(54) Solar Backpack

(71) Applicant: Blackboard Solar, Inc., Flossmoor, IL (US)

(72) Inventors: Malcolm S. Townes, University City, MO (US); David M. Wilson, Flossmoor, IL (US); Aislynn Clark, Lake Forest, CA (US)

(73) Assignee: Blackboard Solar, Inc., Flossmoor, IL (US)

(21) Appl. No.: 18/329,216

(22) Filed: Jun. 5, 2023

Related U.S. Application Data
(60) Provisional application No. 63/349,368, filed on Jun. 6, 2022.

(51) Int. Cl. A45F 3/04; H02S 40/00

(52) U.S. Cl. CPC A45F 3/04; H02S 40/00; A45F 2003/003

(57) ABSTRACT

The backpack may include a removable solar panel, a transparent film to protect the solar panel, a mesh pocket or a connector outside of the pocket. The backpack may comprise a compartment; a removable solar panel configured to be removably inserted into the compartment; a handle interfacing with the removable solar panel; one or more magnets associated with the removable solar panel, wherein the one or more magnets are configured to align the removable solar panel in the compartment; a transparent film over the compartment, wherein the transparent film is configured to protect the removable solar panel while in the compartment; and a removable panel over the transparent film, wherein the removable panel is configured to protect the transparent film and the removable solar panel while in the compartment.

### CROSS-REFERENCE TO RELATED APPLICATIONS

This application claims priority to, and the benefit of, U.S. Provisional Ser. No. 63/349,368 filed on Jun. 6, 2022 and entitled “SOLAR BACKPACK,” the entire contents of which is hereby incorporated by reference for all purposes.

### FIELD

The disclosure generally includes a solar backpack, and more particularly, a solar backpack with a solar panel, a handle on the solar panel to remove and insert the solar panel, magnets to align the solar panel, a transparent film to protect the solar panel, a removable panel to protect the film and the solar panel, a mesh pocket for a power bank, and a connector outside of the pocket.

### BACKGROUND

Backpacks are typically carried over the back. While the back of the backpack lays on the back or shoulder of the person carrying the backpack, the front of the backpack is often facing the sun. As such, incorporating a solar panel into a backpack often allows the backpack to interface with the sun, and generate and store energy. Such energy may be used to charge or power other devices. The other devices may be plugged into components of the backpack and move along with the backpack. The other devices may also be separate devices that can be plugged into the backpack, when desired, when the backpack is placed in a certain location.

### SUMMARY

In various embodiments, the system may include a backpack comprising a compartment; a removable solar panel configured to be removably inserted into the compartment; a handle interfacing with the removable solar panel, wherein the handle is configured to at least one of remove or insert the solar panel into the compartment in the backpack; one or more attachments associated with the removable solar panel, wherein the one or more attachments are configured to align the removable solar panel in the compartment; a transparent film over the compartment, wherein the transparent film is configured to protect the removable solar panel while in the compartment; and a removable panel over the transparent film, wherein the removable panel is configured to protect the transparent film and the removable solar panel while in the compartment.

The backpack may also comprise a mesh pocket configured to retain a power bank and/or a connector located outside of the pocket. The removable panel may interface with the compartment with Velcro. The compartment may include flaps that conceal edges of the removable panel. The solar panel may be in a landscape orientation when inside the compartment. The solar panel may include an edge comprising 600D polyester fabric. The transparent film may comprise ETFE film. The compartment may include one or more attachments that are configured to align with the one or more attachments associated with the removable solar panel.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

The various figures attached hereto show exemplary features of the solar backpack, in accordance with various embodiments.

FIG. 1 is an exemplary perspective view of the backpack, in accordance with various embodiments.

FIG. 2 is an exemplary front view of the backpack, in accordance with various embodiments.

FIG. 3 is an exemplary back view of the backpack, in accordance with various embodiments.

FIG. 4 is an exemplary first side view of the backpack, in accordance with various embodiments.

FIG. 5 is an exemplary second side view of the backpack, in accordance with various embodiments.

FIG. 6 is an exemplary top view of the backpack, in accordance with various embodiments.

FIG. 7 is an exemplary bottom view of the backpack, in accordance with various embodiments.

FIG. 8 is an exemplary exploded view of some of the components of the backpack, in accordance with various embodiments.

FIG. 9 is an exemplary view of a solar panel of the backpack, in accordance with various embodiments.

### DETAILED DESCRIPTION

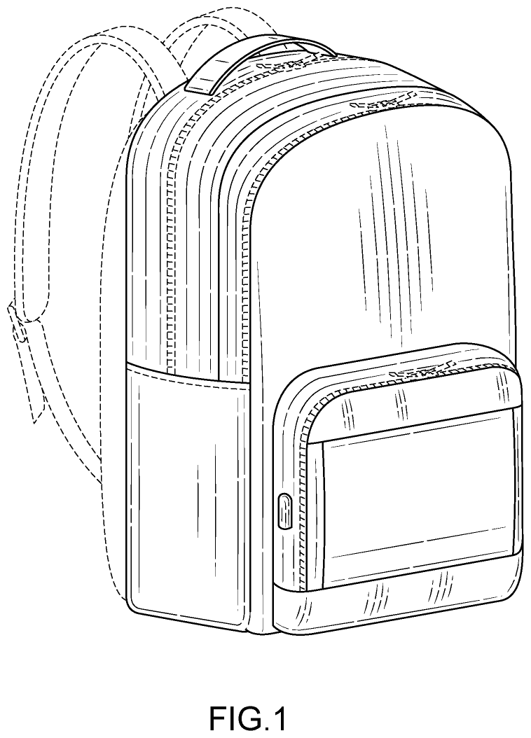

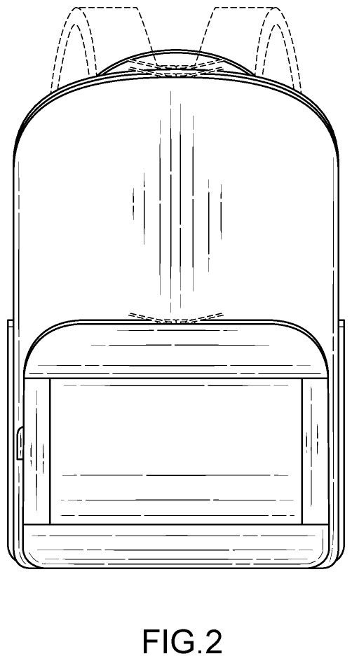

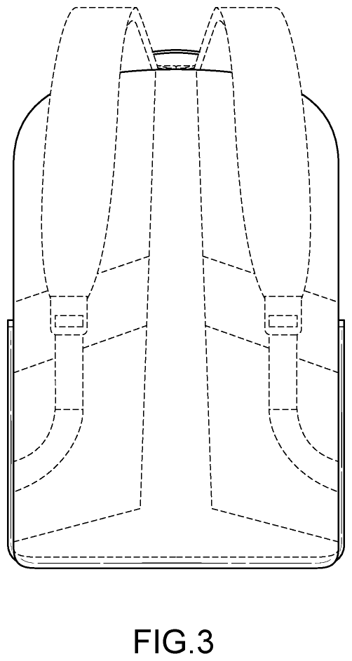

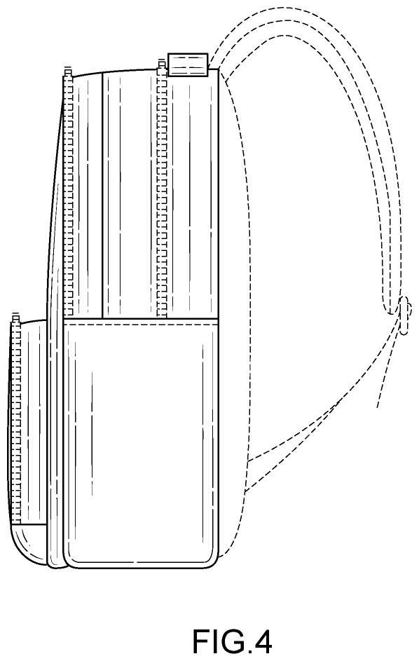

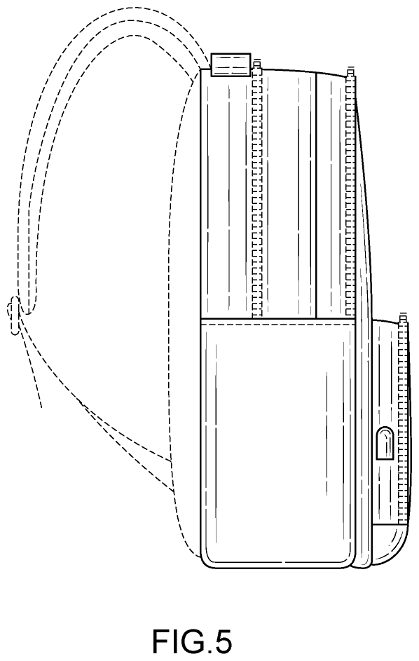

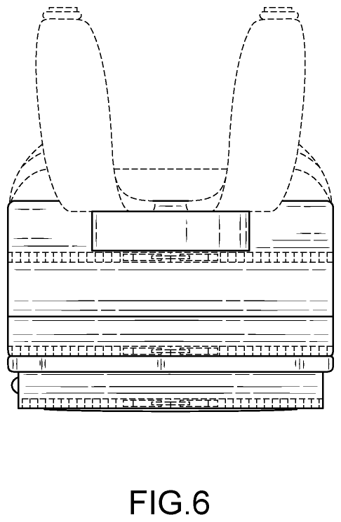

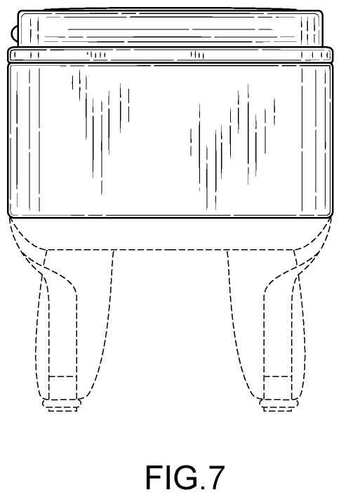

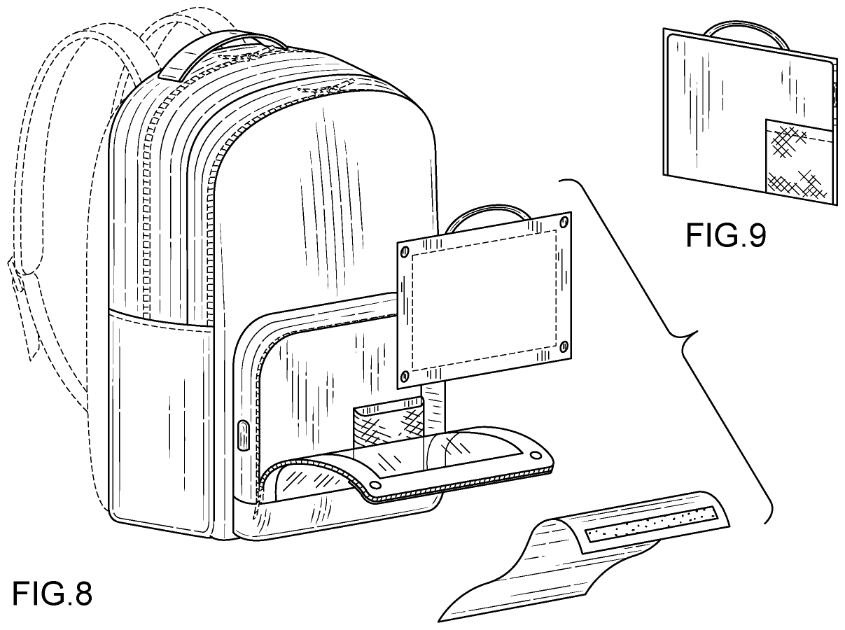

In various embodiments, and with reference to FIGS. 1-7, the system may include a backpack having any dimensions and comprised of any material. The backpack may include one or more straps, adjustable straps, zippers and/or compartments. While some compartments may hold books, supplies and other items, a separate compartment may be available for a solar panel, as best shown in FIGS. 8-9. The height of the side panel of the backpack may align with the compartment that holds the solar panel. The backpack may include one or more of a removable solar panel, a transparent film to protect the solar panel, a mesh pocket (e.g., for a power bank), a removable panel to protect the film and the solar panel and/or a connector outside of the pocket. Any portion of the backpack or its components may be configured for imprinting with text, graphics, logos or other elements.

In various embodiments, and with reference to FIGS. 8-9, the compartment that is configured to hold the solar panel may include a transparent (or semi-transparent) film partially or fully over an outward facing surface of the compartment. The transparent film may protect the solar panel, while still allowing the sun to pass through the transparent film. The solar panel may receive the sun while the solar panel is in the compartment. The transparent film may include ETFE film that adheres to the compartment frame such that the transparent film acts as a window into the pocket. The film may be adhered by sewing, adhesive, clips, snaps, zipper, Velcro and/or the like.

In various embodiments, and with continued reference to FIGS. 8-9, the backpack may include a partially or fully removable panel that may interface with one or more compartments. For example, the removable panel may be configured to be placed over the transparent film to hide and/or protect the film and the solar panel. The panel may provide extra surface area for imprinting. The panel may be any size, shape or composition. The panel may include any type of attachment device to interface with the compartment such as, for example, Velcro, clips, snaps, sewing, temporary adhesive, zipper and/or the like. The panel may be 10 inches in width and 7.87 inches in height, with a 0.5 inch wide Velcro strip. One or more panel Velcro strips may be located on one or more edges of the panel. The compartment may include one or more of the opposite Velcro strips on similar one or more edges. The opposite Velcro strips may be located under flaps on the outside of the compartment, such that the panel Velcro is placed under the flap panel to partially or fully conceal the attachment device. The flaps on the compartment may be formed from sewing around the edges to leave a flap opening. For example, the flaps may be on the top and bottom of the compartment, such that the flaps conceal the top and bottom of the panel and conceal the Velcro on the top and bottom of the panel.

In various embodiments, and with continued reference to FIGS. 8-9, the solar panel may be configured with any type of solar cells, and in any shape and any dimensions. For example, the solar panel may be rectangular shaped. The solar panel may be configured to fit into and/or be removed from a compartment of the backpack. The solar panel may be configured to be inserted into the compartment in a landscape orientation. Placement in a backpack with landscape orientation may increase the amount of surface area on the backpack compartment and on the solar panel that is more exposed to the sun. The solar panel may include any type of edge partially or fully surrounding the active solar panel area that receives the sun's rays. The edge may comprise, for example, 600D polyester fabric.

In various embodiments and with continued reference to FIGS. 8-9, the solar panel may include a handle connected to the solar panel. The handle may be connected to any part of the solar panel. For example, the handle may be connected to the long side of the solar panel. The handle may be comprised of any material such as, for example, leather, plastic, metal, wood and/or the like. The handle may help the user to remove and/or insert the solar panel into the backpack.

In various embodiments and with continued reference to FIGS. 8-9, the solar panel may include, any device to align and/or secure the solar panel within the compartment. The alignment device may include one or more devices located anywhere on the solar panel. The compartment may also include a similar or complementary device that interfaces with or receives the alignment device on the solar panel. For example, the solar panel may include one or more attachments (e.g., magnets, buttons, hooks, Velcro, etc.). The magnets may be located near one or more corners of the solar panel. The compartment may also include magnets such that the magnets on the solar panel interface with the magnets in the compartment. For example, the magnets may be vertically located 5.37 inches apart, and horizontally located 9 inches apart.

In various embodiments and with reference to FIGS. 1-9, the backpack may include a single zipper or double zipper around at least a portion of each of the compartments to close and open the compartments. The double zipper may allow omni-directional positioning of the cables exiting or entering the compartments.

In various embodiments, the backpack may include a component outside of the compartment for easier access. For example, the component may be any electrical device, connector, extender, adapter, etc. The power bank, phone or other device may be secured in a compartment or pocket such that the power cord may exit the compartment and plug into the component outside of the compartment. The backpack may also include a pocket to retain any component. The pocket may be comprised of any material and be formed in any shape. For example, the pocket may be a mesh pocket that houses a power bank.

Various embodiments of this disclosure may incorporate one or more embodiments or features disclosed in U.S. Pat. No. 8,410,748, the entire contents of which is hereby incorporated by reference for all purposes.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A backpack comprising:
a compartment;
a removable solar panel configured to be removably inserted into the compartment;
a handle interfacing with the removable solar panel, wherein the handle is configured to at least one of remove or insert the solar panel into the compartment in the backpack;
one or more attachments associated with the removable solar panel, wherein the one or more attachments are configured to align the removable solar panel in the compartment;
a transparent film over the compartment, wherein the transparent film is configured to protect the removable solar panel while in the compartment; and
a removable panel over the transparent film, wherein the removable panel is configured to protect the transparent film and the removable solar panel while in the compartment.

2. The backpack of claim 1, further comprising a mesh pocket.

3. The backpack of claim 1, further comprising a mesh pocket configured to retain a power bank.

4. The backpack of claim 1, further comprising a connector located outside of the pocket.

5. The backpack of claim 1, wherein the removable panel interfaces with the compartment with Velcro.

6. The backpack of claim 1, wherein the compartment includes flaps that conceal edges of the removable panel.

7. The backpack of claim 1, wherein, when inside the compartment, the solar panel is in at least one of a landscape orientation or horizontal orientation.

8. The backpack of claim 1, wherein the solar panel includes an edge comprising 600D polyester fabric.

9. The backpack of claim 1, wherein the transparent film comprises ETFE film.

10. The backpack of claim 1, wherein the one or more attachments comprise one or more magnets.

11. The backpack of claim 1, wherein the compartment includes one or more attachments that are configured to align with the one or more attachments associated with the removable solar panel.

12. The backpack of claim 10, wherein the compartment includes one or more magnets that are configured to align with the one or more magnets associated with the removable solar panel.
